(19) United States
(12) Patent Application Publication
(10) Pub. No.: US 2014/0225800 A1
(43) Pub. Date: Aug. 14, 2014

(54) APPARATUS AND METHODS TO IMPROVE ANTENNA ISOLATION

(71) Applicant: QUALCOMM INCORPORATED, San Diego, CA (US)

(72) Inventor: Jatupum Jenwatanavet, San Diego, CA (US)

(73) Assignee: QUALCOMM INCORPORATED, San Diego, CA (US)

(21) Appl. No.: 13/765,566

(22) Filed: Feb. 12, 2013

(51) Int. Cl. H01Q 1/52

(52) U.S. Cl. CPC H01Q 1/521
USPC 343/841

(57) ABSTRACT

An antenna apparatus includes a circuit card assembly, a first antenna and a second antenna fabricated on the circuit card assembly, the first antenna and the second antenna configured to operate at substantially the same frequency. A feature located proximate to the first antenna and the second antenna reduces electromagnetic coupling between the first antenna and the second antenna.

### DESCRIPTION OF THE RELATED ART

Electronic devices, such as portable communication devices, continue to diminish in size. All such portable communication devices use some type of antenna for transmitting and receiving communication signals. Some devices use two or more antennas for transmitting and receiving communication signals, and some devices use two or more antennas operating at the same frequency. In applications where two or more antennas are in close proximity to each other and where they operate at the same frequency, the need to isolate each antenna from the signal radiated by the other antenna becomes very important.

Antenna isolation is characterized using the terminology “S21” and refers to the power received by a second antenna (antenna 2) when the generating source is a first antenna (antenna 1). A high S21 measurement means that energy is being coupled from the first antenna to the second antenna, and is generally sought to be avoided.

Therefore, it would be desirable to have a way of improving antenna isolation where two or more antennas are operating in close proximity at or near the same frequency.

### SUMMARY

In an embodiment, an antenna apparatus includes a circuit card assembly, a first antenna and a second antenna fabricated on the circuit card assembly, the first antenna and the second antenna configured to operate at substantially the same frequency, and a feature located proximate to the first antenna and the second antenna, the feature configured to reduce electromagnetic coupling between the first antenna and the second antenna.

### BRIEF DESCRIPTION OF THE DRAWINGS

In the figures, like reference numerals refer to like parts throughout the various views unless otherwise indicated. For reference numerals with letter character designations such as “102a” or “102b”, the letter character designations may differentiate two like parts or elements present in the same figure. Letter character designations for reference numerals may be omitted when it is intended that a reference numeral encompass all parts having the same reference numeral in all figures.

FIG. 1 is a graphical illustration showing an embodiment of an apparatus for improving antenna isolation.

FIGS. 2A through 2K are diagrams illustrating embodiments of the isolation feature of FIG. 1.

FIG. 3 is a schematic diagram of an embodiment of the apparatus for improving antenna isolation of FIG. 1.

FIGS. 4A and 4B are diagrams illustrating S21 performance of an example antenna system.

FIG. 5 is a graphical illustration showing another embodiment of an apparatus for improving antenna isolation.

FIGS. 6A, 6B and 6C are diagrams illustrating alternative embodiments of the isolation feature shown in FIG. 5.

FIG. 7 is a schematic diagram of an embodiment of the apparatus for improving antenna isolation of FIG. 5.

FIGS. 8A and 8B are diagrams illustrating S21 performance of an example antenna system.

FIG. 9 is a block diagram illustrating an example of a wireless device in which the apparatus and method for improving antenna isolation can be implemented.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

The apparatus and method for improving antenna isolation can be incorporated into or used with a communication device, such as, but not limited to, a cellular telephone, a computing device, such as a smart phone, a tablet computer, or any other communication device.

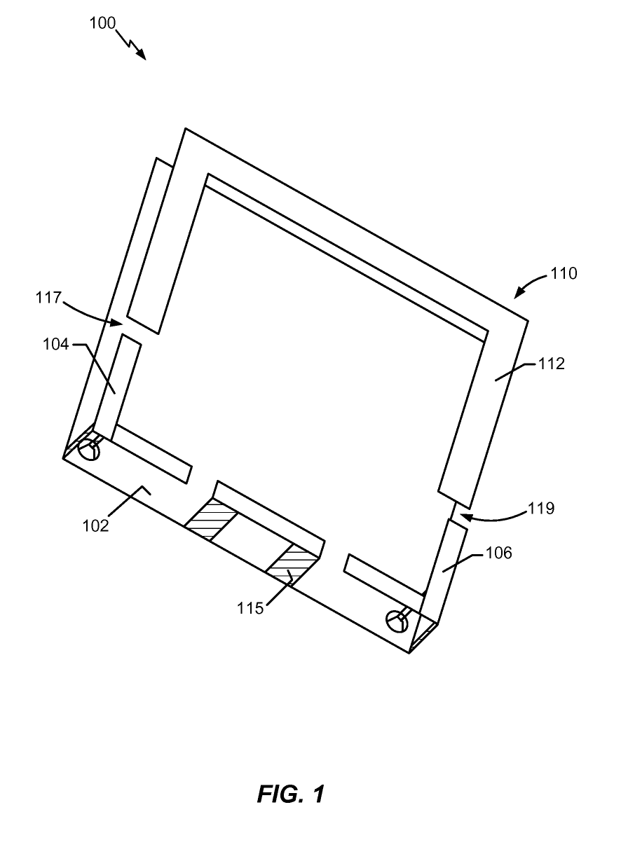

FIG. 1 is a graphical illustration showing an embodiment of an apparatus for improving antenna isolation. The apparatus 100 comprises a circuit card assembly 102 having a first antenna 104 and a second antenna 106. Details of the circuit card assembly 102 are not shown for simplicity of illustration. Although shown as a general “L” shape, the first antenna 104 and the second antenna 106 can be different shapes and configurations. Moreover, in this embodiment, the first antenna 104 and the second antenna 106 are not in the same plane as the circuit card assembly 102; but, in an embodiment, can be located in the same plane as the circuit card assembly 102.

To reduce electromagnetic coupling between the first antenna 104 and the second antenna 106, an isolation feature 110 is formed proximate to the first antenna 104, the second antenna 106, and the circuit card assembly 102. In this embodiment, the isolation feature 110 is an electrically conductive metal or metallic structure that is formed proximate to the first antenna 104, the second antenna 106, and to the circuit card assembly 102. The isolation feature 110 alters the current distribution between the first antenna 104 and the second antenna 106. In an embodiment, the isolation feature 110 comprises a first portion 112 and a second portion 115. In an embodiment, the first portion 112 can be electrically floating and the second portion 115 can be electrically grounded. However, in alternative embodiments, the first portion 112 can be electrically grounded and the second portion 115 can be electrically floating; or both the first portion 112 and the second portion 115 can be electrically floating or can be electrically grounded.

A gap 117 between the first portion 112 and the first antenna 104; and a gap 119 between the first portion 112 and the second antenna 106 causes the first antenna 104 and the second antenna 106 to electromagnetically couple to the first portion 112 instead of electromagnetically coupling to each other. The dimensions of the first portion 112, the gaps 117 and 119, and the antennas 104 and 106 can be designed to cause the electromagnetic coupling to occur at a frequency or frequencies that is or are different from the operating frequency at which a communication device having the first antenna 104 and the second antenna 106 is communicating, thus reducing the S21 coupling between the first antenna 104 and the second antenna 106 at the operating frequency, and thereby improving the electromagnetic isolation between the first antenna 104 and the second antenna 106 at the operating frequency.

In an embodiment, the first portion 112 is electrically floating, in that it is not connected to the circuit card assembly 102 or to either the first antenna 104 or to the second antenna 106. In an embodiment, the second portion 115 is electrically connected to a circuit ground on the circuit card assembly 102. In an embodiment, the isolation feature 110 is formed in the same plane as the first antenna 104 and the second antenna 106, and operates to minimize electromagnetic coupling between the first antenna 104 and the second antenna 106, by causing the antennas 104 and 106 to electromagnetically couple to the isolation feature 110 at a frequency that is different than the operating frequency instead of coupling to each other at the operating frequency.

In an alternative embodiment, the isolation feature 110 need not be located or formed in the same plane as the antennas 104 and 106, but instead, may be located or formed in a plane other than the plane in which the antennas 104 and 106 are located. In yet another embodiment, the isolation feature 110 may be formed in the same plane as the antennas 104 and 106, but could occupy a smaller area than the area occupied by the antennas 104 and 106.

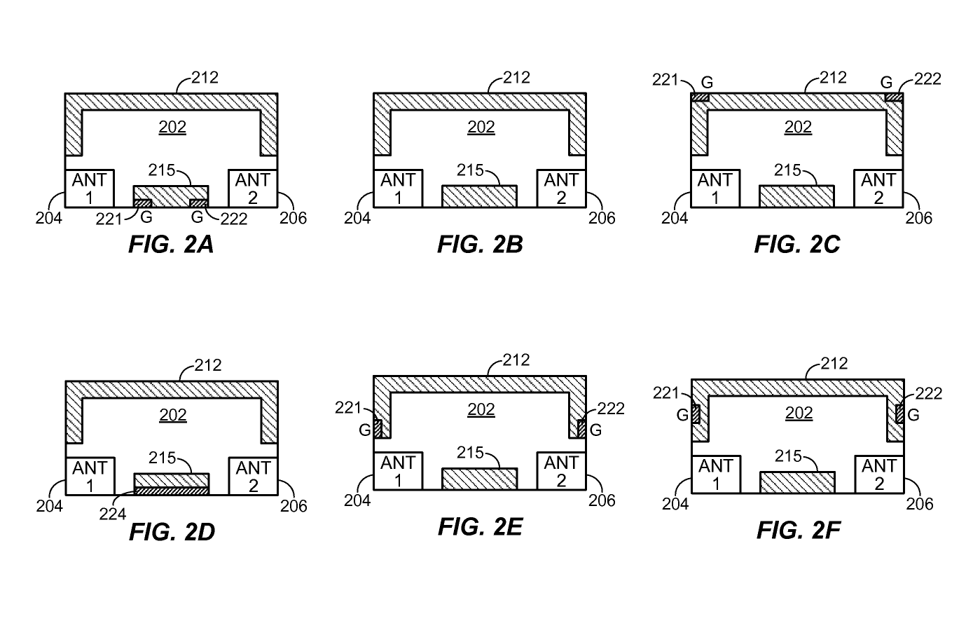

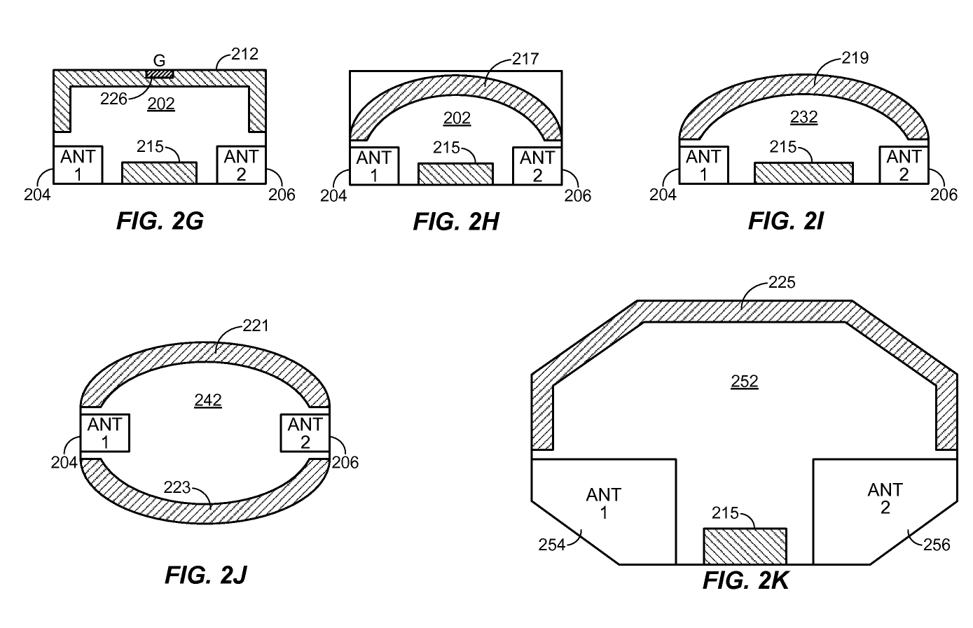

FIGS. 2A through 2K are diagrams illustrating embodiments of the isolation feature of FIG. 1. Reference numerals for elements in FIGS. 2A through 2K that are similar to corresponding elements in FIG. 1 are labeled according to the convention 2XX, where XX in FIGS. 2A through 2K denote a corresponding similar element in FIG. 1. In each of FIGS. 2A through 2K, the first antenna 204 and the second antenna 206 are shown for reference, as is the circuit card assembly 202.

In FIG. 2A, the first portion 212 is electrically floating and the second portion 215 is electrically grounded to the circuit card assembly 202 through ground connections 221 and 222.

In FIG. 2B, the first portion 212 is electrically floating and the second portion 215 is electrically floating.

In FIG. 2C, the first portion 212 is electrically grounded to the circuit card assembly 202 through ground connections 221 and 222, and the second portion 215 is electrically floating.

In FIG. 2D, the first portion 212 is electrically floating and the second portion 215 is electrically grounded to the circuit card assembly 202 through a single ground connection 224.

In FIG. 2E, the first portion 212 is electrically grounded to the circuit card assembly 202 through ground connections 221 and 222, and the second portion 215 is electrically floating.

In FIG. 2F, the first portion 212 is electrically grounded to the circuit card assembly 202 through ground connections 221 and 222, and the second portion 215 is electrically floating.

In FIG. 2G, the first portion 212 is electrically grounded to the circuit card assembly 202 through a single ground connection 226, and the second portion 215 is electrically floating.

In FIG. 2H, the first portion 217 has a configuration that is different from the first portion 212 and is electrically floating and the second portion 215 is electrically floating. The first portion 217 is otherwise functionally similar to the first portion 212. However, any of the first portion 217 and the second portion 215 could be electrically grounded to the circuit card assembly 202 at any location on any of the first portion 217 and the second portion 215.

In FIG. 2I, the first portion 219 has a configuration that is different from the first portion 212 and the first portion 217 and is electrically floating and the second portion 215 is electrically floating. The first portion 219 is otherwise functionally similar to the first portion 212 and the first portion 217. However, any of the first portion 219 and the second portion 215 could be electrically grounded to the circuit card assembly 232 at any location on any of the first portion 219 and the second portion 215. The circuit card assembly 232 has a configuration that is different than the circuit card assembly 202 described above, but is otherwise functionally similar to the circuit card assembly 202.

In FIG. 2J, the first portion 221 has a configuration that is different from the first portion 212, the first portion 217 and the first portion 219 and is electrically floating and the second portion 223 is electrically floating. The first portion 221 is otherwise functionally similar to the first portion 212, the first portion 217 and the first portion 219. The second portion 223 has a configuration that is different than the second portion 215, but is otherwise functionally similar. However, any of the first portion 221 and the second portion 223 could be electrically grounded to the circuit card assembly 242 at any location on any of the first portion 221 and the second portion 223. The circuit card assembly 242 has a configuration that is different than the circuit card assembly 202 described above, but is otherwise functionally similar to the circuit card assembly 202.

In FIG. 2K, the first portion 225 is electrically floating and the second portion 215 is electrically floating. The first portion 225 is otherwise functionally similar to the first portion 212, the first portion 217, the first portion 219 and the first portion 221. However, any of the first portion 225 and the second portion 215 could be electrically grounded to the circuit card assembly 252 at any location on any of the first portion 225 and the second portion 215. The circuit card assembly 252 has a configuration that is different than the circuit card assembly 202 described above, but is otherwise functionally similar to the circuit card assembly 202. The first antenna 254 and the second antenna 256 have configurations different than the first antenna 204 and the second antenna 206, respectively, but are otherwise functionally similar.

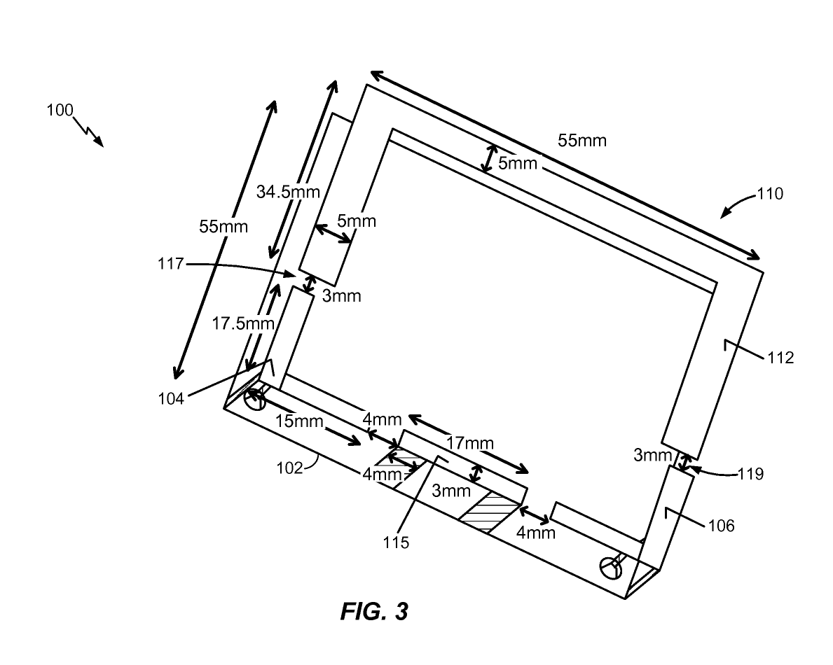

FIG. 3 is a schematic diagram of an embodiment of the apparatus for improving antenna isolation of FIG. 1. The dimensions shown in FIG. 3 are in millimeters (mm) and are shown to illustrate one possible embodiment of the apparatus for improving antenna isolation of FIG. 1. Other dimensions are possible depending on implementation and operating frequency.

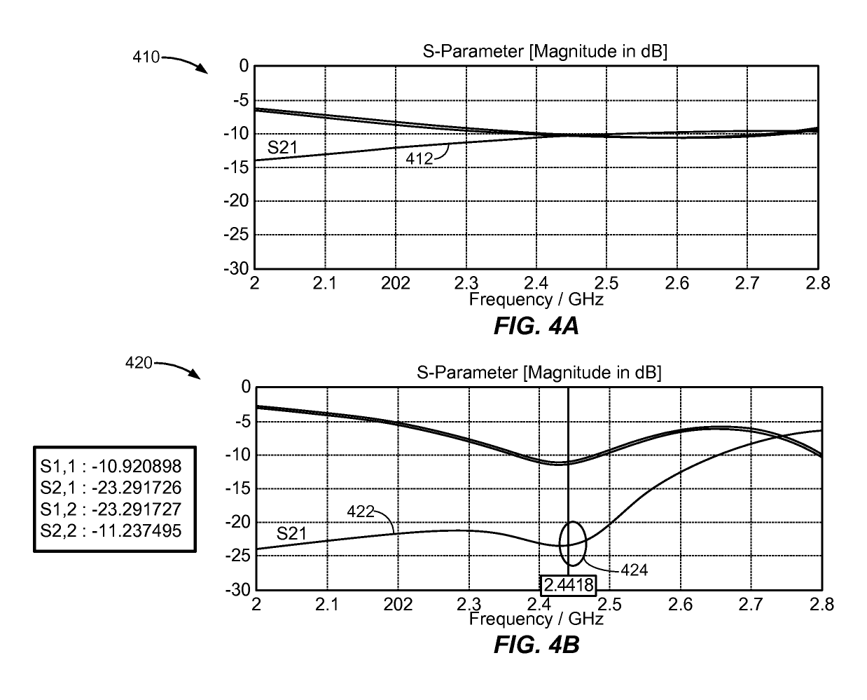

FIGS. 4A and 4B are diagrams illustrating S21 performance of an example antenna system. FIG. 4A illustrates a graph 410 showing example S21 performance of an antenna system that does not include the apparatus and method for improving antenna isolation. FIG. 4B illustrates a graph 420 showing example S21 performance of an antenna system that does include the apparatus and method for improving antenna isolation.

In FIG. 4A, the trace 412 illustrates example S21 performance. In FIG. 4B, the trace 422 illustrates example S21 performance and shows that at a frequency of interest 424 (for example, 2.4418 GHz), the isolation feature 110 significantly reduces electromagnetic coupling between the first antenna 104 and the second antenna 106 compared to the electromagnetic coupling between the first antenna 104 and the second antenna 106 shown by trace 412.

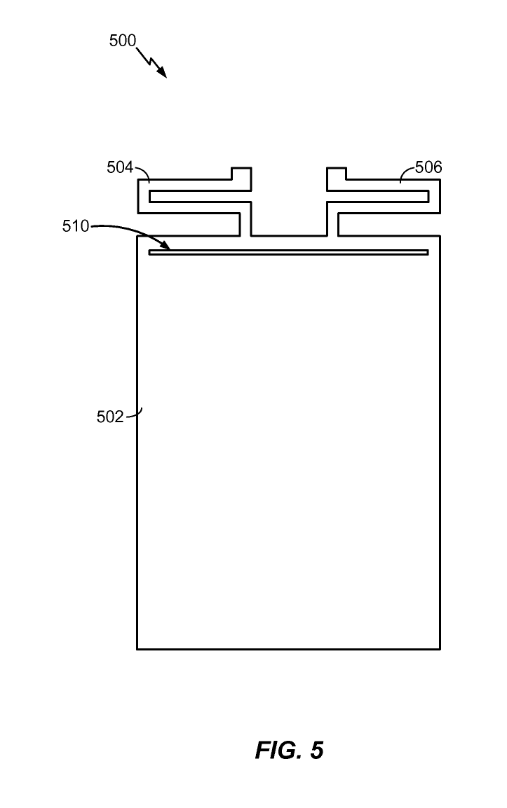

FIG. 5 is a graphical illustration showing another embodiment of an apparatus for improving antenna isolation. The apparatus 500 comprises a circuit card assembly 502 having a first antenna 504 and a second antenna 506. Details of the circuit card assembly 502 are not shown for simplicity of illustration. The shape of the first antenna 504 and the second antenna 506 is arbitrarily shown as a meandering pattern. The first antenna 504 and the second antenna 506 can have any shape or pattern. To reduce electromagnetic coupling between the first antenna 504 and the second antenna 506, an isolation feature 510 is formed in the circuit card assembly 502. In an embodiment, the isolation feature 510 is a slot formed in the circuit card assembly 502. In an embodiment, the isolation feature 510 is formed to extend within the periphery of the circuit card assembly 502, such that the isolation feature 510 does not extend to any edge of the circuit card assembly 502.

In an embodiment, the isolation feature 510 is formed in the same plane as the antennas 504 and 506, and operates to alter the current flowing to the first antenna 504 and the second antenna 506. In this manner, the isolation feature 510 has the effect of minimizing the electromagnetic coupling between the first antennas 504 and the second antenna 506 by creating a resonant frequency other than the communication frequency in the frequency band of interest. Creating a resonant frequency other than the communication frequency in the frequency band of interest has the effect of increasing the S21 isolation between the first antennas 504 and the second antenna 506 at the communication frequency, which is also referred to as the frequency of interest. The dimensions (length and width) and the location of the isolation feature 510 relative to the first antenna 504 and the second antenna 506 dictate the resonant frequency and the S21 isolation performance.

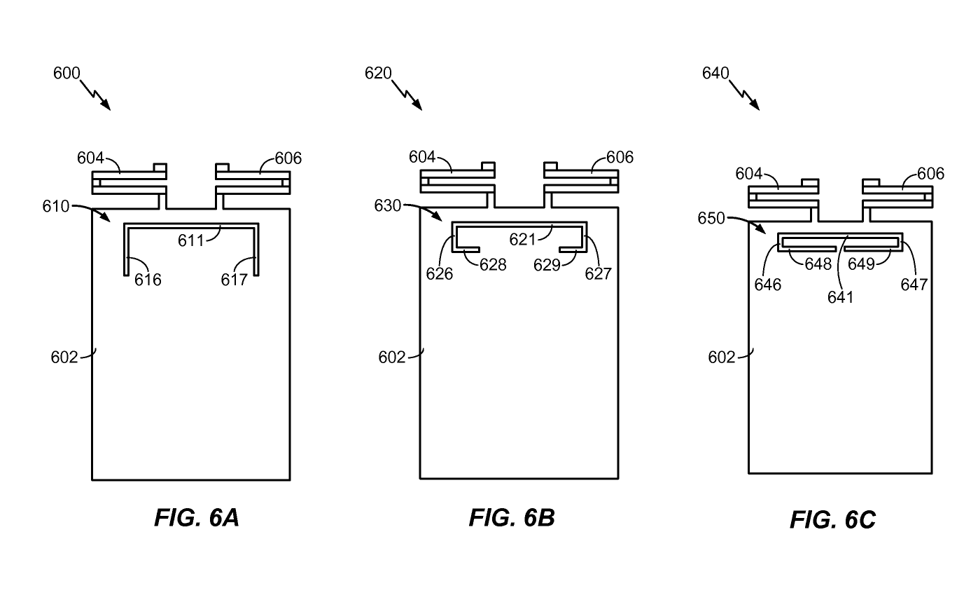

FIGS. 6A, 6B and 6C are diagrams illustrating alternative embodiments of the isolation feature 510 shown in FIG. 5. Reference numerals for elements in FIGS. 6A through 6C that are similar to corresponding elements in FIG. 5 are labeled according to the convention 6XX, where XX in FIGS. 6A through 6C denote a corresponding element in FIG. 5. n each of FIGS. 6A through 6C, the first antenna 604 and the second antenna 606 are shown for reference, as is the circuit card assembly 602. Details of the circuit card assembly 602 are not shown for simplicity of illustration.

In FIG. 6A, the isolation feature 610 comprises a slot that has a generally “U” shaped pattern including segment 611 and legs 616 and 617 The isolation feature 610 is formed to extend within the periphery of the circuit card assembly 602, such that the isolation feature 610 does not extend to any edge of the circuit card assembly 602.

In FIG. 6B, the isolation feature 630 comprises a slot that has a generally “U” or “C” shaped pattern including segment 621 and legs 626, 627, 628 and 629. The isolation feature 630 is formed to extend within the periphery of the circuit card assembly 602, such that the isolation feature 630 does not extend to any edge of the circuit card assembly 602.

In FIG. 6C, the isolation feature 650 comprises a slot that has a generally “U” or “C” shaped pattern including segment 641 and legs 646, 647, 648 and 649. The isolation feature 650 is formed to extend within the periphery of the circuit card assembly 602, such that the isolation feature 650 does not extend to any edge of the circuit card assembly 602.

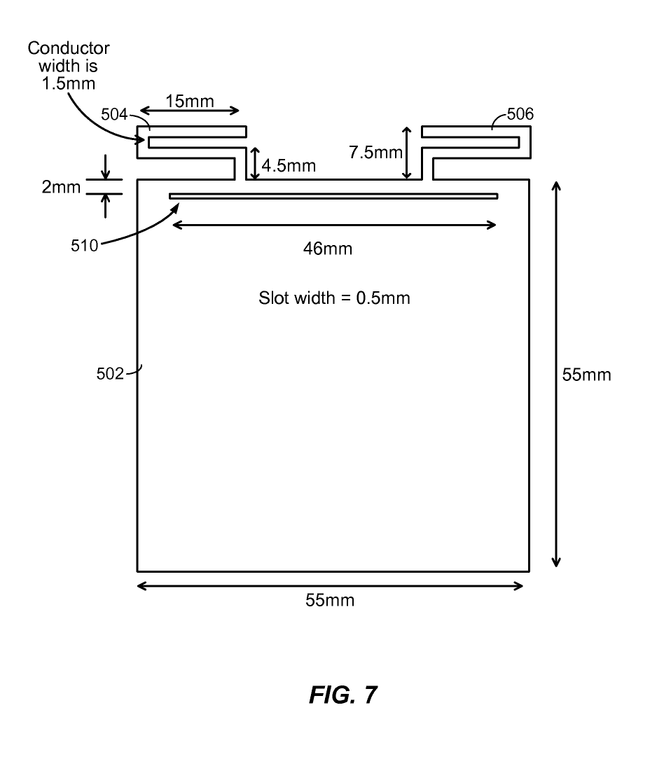

FIG. 7 is a schematic diagram of an embodiment of the apparatus for improving antenna isolation of FIG. 5. The dimensions shown in FIG. 7 are in millimeters (mm) and are shown to illustrate one possible embodiment of the apparatus for improving antenna isolation of FIG. 5. Other dimensions are possible depending on implementation and operating frequency.

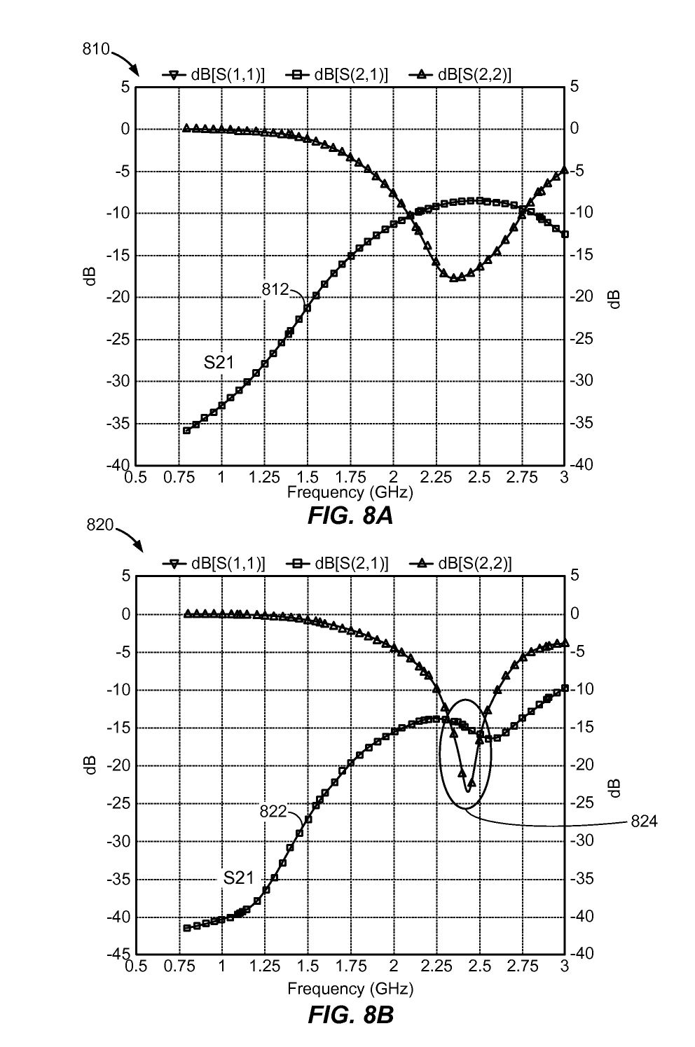

FIGS. 8A and 8B are diagrams illustrating S21 performance of an example antenna system. FIG. 8A illustrates a graph 810 showing example S21 performance of an antenna system that does not include the apparatus and method for improving antenna isolation. FIG. 8B illustrates a graph 820 showing example S21 performance of an antenna system that does include the apparatus and method for improving antenna isolation.

In FIG. 8A, the trace 812 illustrates example S21 performance. In FIG. 8B, the trace 822 illustrates example S21 performance and shows that at a frequency of interest 824 (i.e., the resonant frequency at approximately 2.45 GHz), the isolation feature 510 significantly reduces electromagnetic coupling between the first antenna 504 and the second antenna 506 because electromagnetic coupling between the first antenna 504 and the isolation feature 510; and electromagnetic coupling between the second antenna 506 and the isolation feature 510 occurs predominately at a frequency other than the frequency of interest. In this example, the trace 822 shows that the electromagnetic coupling between the first antenna 504 and the isolation feature 510; and the electromagnetic coupling between the second antenna 506 and the isolation feature 510 is stronger at a frequency of 3 GHz an above than that shown by the trace 812 in FIG. 8A. In this manner, the isolation feature 510 significantly reduces electromagnetic coupling between the first antenna 504 and the second antenna 506 at the frequency of interest.

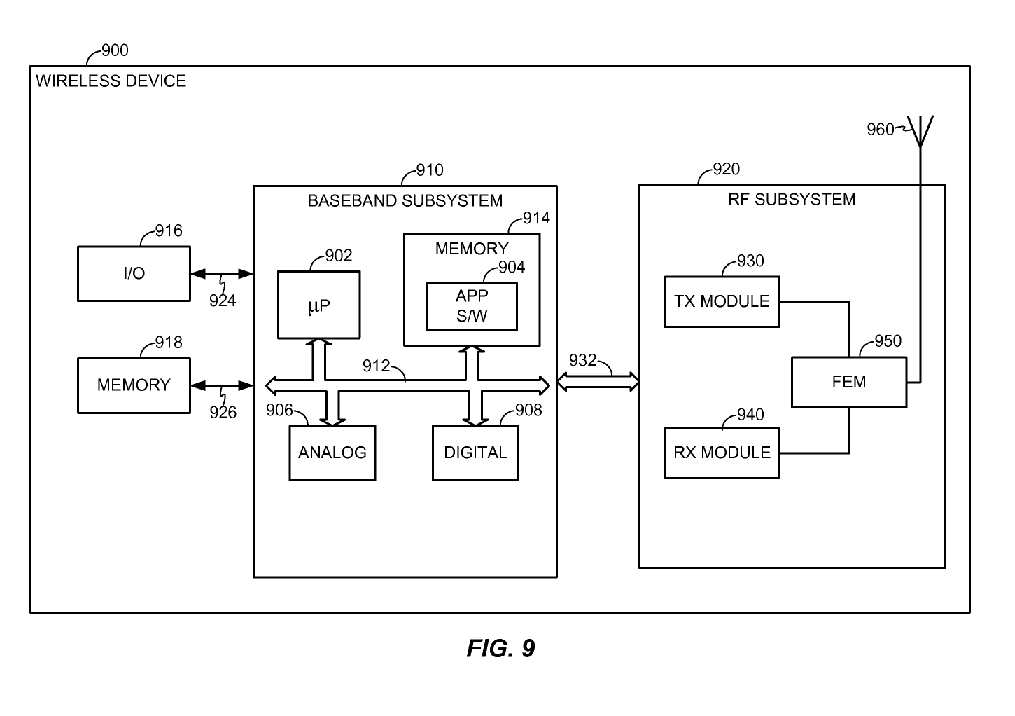

FIG. 9 is a block diagram illustrating an example of a wireless device 900 in which the apparatus and method for improving antenna isolation can be implemented. In an embodiment, the wireless device 900 can be a “Bluetooth” wireless communication device, a portable cellular telephone, a WiFi enabled communication device, or can be any other communication device. Embodiments of the apparatus and method for improving antenna isolation can be implemented in any communication device. The wireless device 900 illustrated in FIG. 9 is intended to be a simplified example of a cellular telephone and to illustrate one of many possible applications in which the apparatus and method for improving antenna isolation can be implemented. One having ordinary skill in the art will understand the operation of a portable cellular telephone, and, as such, implementation details are omitted. In an embodiment, the wireless device 900 includes a baseband subsystem 910 and an RF subsystem 920 connected together over a system bus 932. The system bus 932 can comprise physical and logical connections that couple the above-described elements together and enable their interoperability. In an embodiment, the RF subsystem 920 can be a wireless transceiver. Although details are not shown for clarity, the RF subsystem 920 generally includes a transmit module 930 having modulation, upconversion and amplification circuitry for preparing a baseband information signal for transmission, includes a receive module 940 having amplification, filtering and downconversion circuitry for receiving and downconverting an RF signal to a baseband information signal to recover data, and includes a front end module (FEM) 950 that includes diplexer circuitry, duplexer circuitry, or any other circuitry that can separate a transmit signal from a receive signal, as known to those skilled in the art. An antenna 960 is connected to the FEM 950. The antenna 960 can comprise any of the embodiments of the apparatus and method for improving antenna isolation as described herein. When implemented as shown in FIG. 9, the apparatus and method for improving antenna isolation can be implemented as part of one or modules that comprise the RF subsystem 920 and the antenna 960.

The baseband subsystem generally includes a processor 902, which can be a general purpose or special purpose microprocessor, memory 914, application software 904, analog circuit elements 906, and digital circuit elements 908, coupled over a system bus 912. The system bus 912 can comprise the physical and logical connections to couple the above-described elements together and enable their interoperability.

An input/output (I/O) element 916 is connected to the baseband subsystem 910 over connection 924 and a memory element 918 is coupled to the baseband subsystem 910 over connection 926. The I/O element 916 can include, for example, a microphone, a keypad, a speaker, a pointing device, user interface control elements, and any other devices or system that allow a user to provide input commands and receive outputs from the wireless device 900.

The memory 918 can be any type of volatile or non-volatile memory, and in an embodiment, can include flash memory. The memory element 918 can be permanently installed in the wireless device 900, or can be a removable memory element, such as a removable memory card.

The processor 902 can be any processor that executes the application software 904 to control the operation and functionality of the wireless device 900. The memory 914 can be volatile or non-volatile memory, and in an embodiment, can be non-volatile memory that stores the application software 904.

The analog circuitry 906 and the digital circuitry 908 include the signal processing, signal conversion, and logic that convert an input signal provided by the I/O element 916 to an information signal that is to be transmitted. Similarly, the analog circuitry 906 and the digital circuitry 908 include the signal processing elements used to generate an information signal that contains recovered information. The digital circuitry 908 can include, for example, a digital signal processor (DSP), a field programmable gate array (FPGA), or any other processing device. Because the baseband subsystem 910 includes both analog and digital elements, it can be referred to as a mixed signal device (MSD).

In view of the disclosure above, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the figures which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and Blu-Ray disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the spirit and scope of the present invention, as defined by the following claims.

What is claimed is:

1. A communication device, comprising:
a circuit card assembly;
a first antenna and a second antenna fabricated on the circuit card assembly, the first antenna and the second antenna configured to operate at substantially the same frequency; and
a feature located proximate to the first antenna and the second antenna, the feature configured to reduce electromagnetic coupling between the first antenna and the second antenna.

2. The communication device of claim 1, wherein the feature comprises a slot formed in the circuit card assembly.

3. The communication device of claim 2, wherein the slot is located within a periphery of the circuit card assembly.

4. The communication device of claim 1, wherein the feature comprises a three-dimensional structure.

5. The communication device of claim 4, wherein the three-dimensional structure comprises a floating portion and a grounded portion.

6. The communication device of claim 5, wherein the grounded portion is grounded to the circuit card assembly.

7. The communication device of claim 4, wherein the three-dimensional structure comprises a first floating portion and a second floating portion.

8. An antenna apparatus, comprising:
a circuit card assembly;
a first antenna and a second antenna fabricated on the circuit card assembly, the first antenna and the second antenna configured to operate at substantially the same frequency; and
a feature located proximate to the first antenna and the second antenna, the feature configured to reduce electromagnetic coupling between the first antenna and the second antenna.

9. The antenna apparatus of claim 8, wherein the feature comprises a slot formed in the circuit card assembly.

10. The antenna apparatus of claim 9, wherein the slot is located within a periphery of the circuit card assembly.

11. The antenna apparatus of claim 8 wherein the feature comprises a three-dimensional structure.

12. The antenna apparatus of claim 11, wherein the three-dimensional structure comprises a floating portion and a grounded portion.

13. The antenna apparatus of claim 12, wherein the grounded portion is grounded to the circuit card assembly.

14. The antenna apparatus of claim 8, wherein the three-dimensional structure comprises a first floating portion and a second floating portion.

15. A method for antenna isolation, comprising:
forming a first antenna and a second antenna on a circuit card assembly, the first antenna and the second antenna configured to operate at substantially the same frequency; and
forming a feature proximate to the first antenna and the second antenna, the feature configured to reduce electromagnetic coupling between the first antenna and the second antenna.

16. The method of claim 15, wherein forming the feature comprises forming a slot in the circuit card assembly.

17. The method of claim 16, wherein forming the slot comprises locating the slot within a periphery of the circuit card assembly.

18. The method of claim 15 wherein forming the feature comprises forming a three-dimensional structure.

19. The method of claim 18, wherein the three-dimensional structure comprises a floating portion and a grounded portion.

20. The method of claim 19, further comprising grounding the grounded portion to the circuit card assembly.

21. The method of claim 18, wherein the three-dimensional structure comprises a first floating portion and a second floating portion.
